(19) United States
(12) Patent Application Publication
(10) Pub. No.: US 2007/0045599 A1
(43) Pub. Date: Mar. 1, 2007

(54) Mining bit puller with striking pad

(75) Inventors: Michael Lee Bilyeu, Bedford, PA (US); Donald E. Keller, Bedford, PA (US)

Correspondence Address: KENNAMETAL INC., P.O. BOX 231, 1600 TECHNOLOGY WAY, LATROBE, PA, 15650, US

(73) Assignee: Kennametal Inc., Latrobe, PA (US)

(21) Appl. No.: 11/216,204

(22) Filed: Aug. 31, 2005

(51) Int. Cl. B66F 15/00

(52) U.S. Cl. 254/25

(57) ABSTRACT

A mining bit puller having a striking pad is disclosed. The puller has a plate with two forks at a front end and a striking pad at a back end. In one embodiment, the forks are generally wedge shaped, and the puller includes a handle extending at an angle from the top of the bit puller plate. During mining tool bit changeout operations, the pad may be struck with a hammer or other tool in order to force the forks between a collar of the tool bit and its mounting block to pull the tool bit out of the block.

### FIELD OF THE INVENTION

The present invention relates to mining bit extractors, and more particularly relates to a puller having a striking pad.

### BACKGROUND INFORMATION

Mining tools include generally conical tool bits which are removably installed in mounting blocks attached to rotating drums. When the tool bits become worn, they are pulled from their blocks and replaced. Puller tools are used to extract the tool bits. One type of puller has wedge-shaped forks which slide between a collar of the tool bit and the mounting block to force the bit out of the block. In order to insert the forks, it is often necessary to strike the back of the puller. However, in conventional pullers, striking of the puller with a hammer or other tool can cause flying metal shards.

### SUMMARY OF THE INVENTION

The present invention provides a mining bit puller having a striking pad. The puller has a plate with two forks at a front end and a striking pad at a back end. During mining tool bit changeout operations, the pad may be struck with a hammer or other tool in order to force the forks between a collar of the tool bit and its mounting block to pull the tool bit out of the block.

An aspect of the present invention is to provide a mining bit puller for extracting mining tool bits. The puller comprises a bit puller plate including two forks at a front end of the plate and a striking pad at a back end of the plate. In one embodiment, the forks are generally wedge shaped, and the puller includes a handle extending at an angle from the top of the bit puller plate.

Another aspect of the present invention is to provide a mining bit puller for extracting mining tool bits, wherein the puller comprises a bit puller plate including two forks at a front end of the plate, and a back end of the plate is structured and arranged to receive a striking pad.

A further aspect of the present invention is to provide a striking pad for a mining bit puller, wherein the striking pad comprises a striking surface, and means for connecting the striking pad to the puller.

These and other aspects of the present invention will be more apparent from the following description.

### BRIEF DESCRIPTION OF THE DRAWINGS

FIG. 1 is an isometric view of a mining bit puller including a striking pad in accordance with an embodiment of the present invention.

FIG. 2 is a side view of the mining bit puller of FIG. 1.

FIG. 3 is a rear view of the mining bit puller of FIG. 1.

FIG. 4 is a top view of a bit puller plate with a portion of the plate and a striking pad shown in section in accordance with an embodiment of the present invention.

FIG. 5 is a side view of the bit puller plate of FIG. 4 with a portion of the plate and the striking pad shown in section.

FIG. 6 is a rear view of a bit puller plate including an annular recess and threaded hole in accordance with an embodiment of the present invention.

FIG. 7 is a side view of a puller striking pad in accordance with an embodiment of the present invention.

FIG. 8 is an isometric view showing the rear of a bit puller plate including a rectangular striking pad in accordance with another embodiment of the present invention.

### DETAILED DESCRIPTION

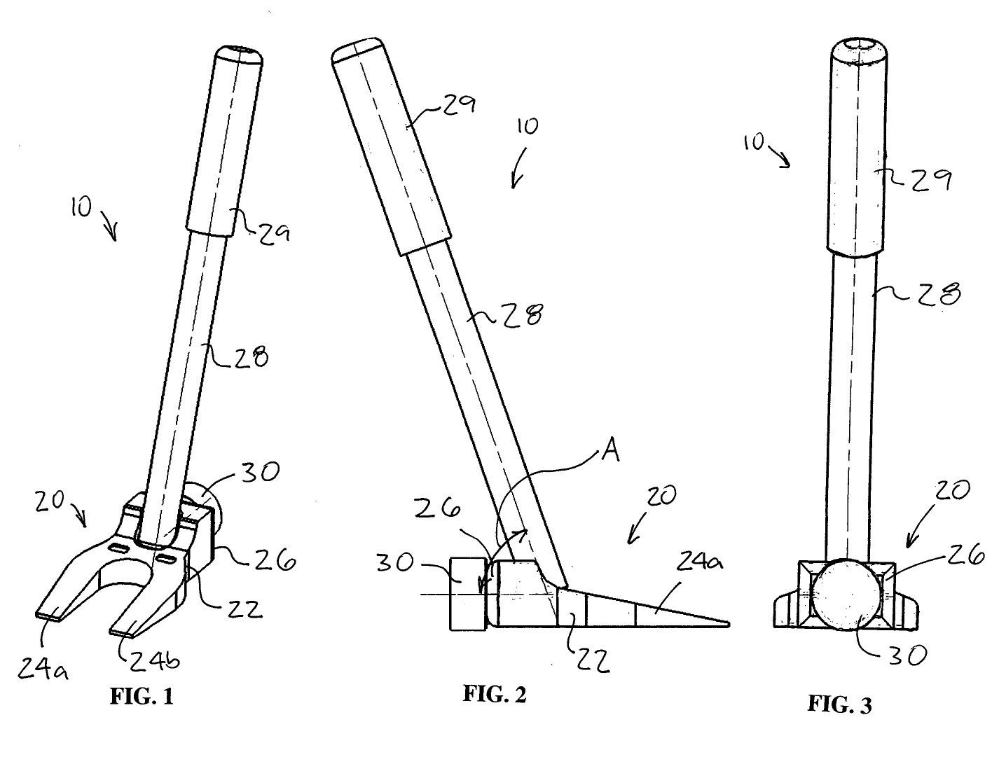

FIGS. 1-3 illustrate a mining bit puller 10 having a bit puller plate 20 in accordance with an embodiment of the present invention. The bit puller plate 20 includes a mid section 22, a front end having two generally wedge-shaped forks 24a and 24b, and a back end 26. The forks 24a and 24b are structured and arranged to be inserted between a mining tool bit and its mounting block in order to remove the tool bit from its block. A handle 28 extends at an angle A from the top of the bit puller plate 20. For example, the handle 28 may be oriented at an angle A of less than 90 degrees with respect to a plane defined by the bit puller plate 20, e.g., from about 40 or 50 degrees to about 70 or 80 degrees. A hand grip 29 is provided at the end of the handle 28. The bit puller plate 20 and the handle 28 may be made of any suitable material such as steel. The bit puller plate 20 and handle 28 may be welded together. The hand grip 29 may be made of any suitable material such as rubber or plastic.

In accordance with the present invention, a striking pad 30 is provided at the back end 26 of the bit puller plate 20. The striking pad 30 is preferably made of a resilient material such as polymers, plastics, elastomers, rubber, soft metals, leather, wood products, natural fibers or the like. When the puller 10 is used for extracting mining tool bits (not shown), the wedge-shaped forks 24a and 24b may be forced between a collar of the tool bit and its mounting block by striking the pad 30 with a hammer or other suitable tool. The striking pad 30 thus should be made of a material capable of withstanding repeated striking forces.

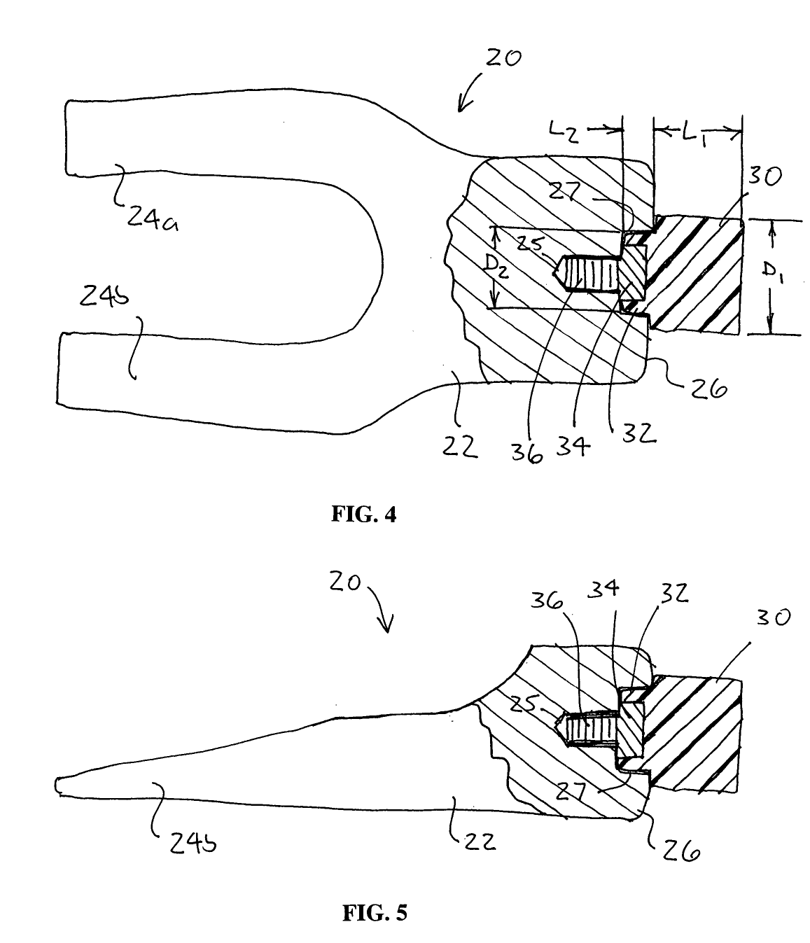

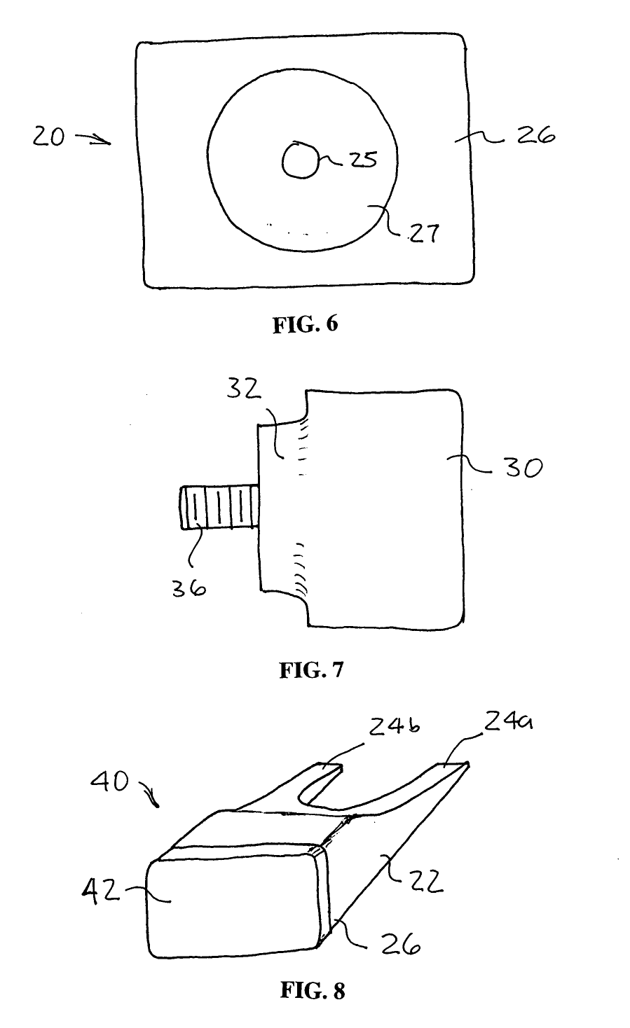

The striking pad 30 may be fastened to the back end 26 of the bit puller plate 20 by any suitable means such as mechanical fasteners, press fittings, welding, adhesives and the like. FIGS. 4-7 illustrate embodiments of the present invention in which the striking pad 30 is fastened to the back end 26 of the bit puller plate 20 by mechanical fastening. In this embodiment, the striking pad 30 has a circular cross section and includes a circular extension 32 extending in an axial direction from the striking pad 30. The extended portion 32 is received in an annular recess 27 in the back 26 of the bit puller plate 20.

As shown in FIG. 4, the body of the striking pad 30 has an axial length L₁ which is greater than an axial length L₂ of the extended portion 32. For example, the axial length L₁ may be from about 0.5 to about 10 times greater than the axial length L₂ of the extended portion 32. The axial length L₁ is typically from about 0.25 to about 1.5 inches, while the axial length L₂ of the extended portion 32 is typically from zero to about 0.75 inch.

As shown in FIG. 4, the body of the striking pad 30 has a diameter D₁ which is greater than a diameter D₂ of the extended portion 32. For example, the diameter D₁ may be from about 0.1 to about 5 times greater than the diameter D₂ of the extended portion 32. The diameter D₁ may typically be from about 0.5 to about 2 or 3 inches, while the diameter D₂ may typically be from about 0.5 to about 2 inches.

As shown most clearly in FIGS. 4, 5 and 7, the striking pad 30 includes a threaded bolt 36 which may be attached to a metal plate 34 at least partially embedded in the striking pad 30. The metal plate 34 may be integrally formed with the threaded shaft 36, e.g., the plate 34 may comprise a bolt head.

As shown most clearly in FIGS. 4-6, the bit puller plate 20 includes an annular recess 27 with a threaded hole 25 at the center thereof. The extended portion 32 of the striking pad 30 fits within the annular recess 27 of the bit puller plate 20. The threaded shaft 36 of the striking pad 30 may be threaded into the hole 25 of the bit puller plate 20. Although the striking pad 30 is mechanically fastened to the bit puller plate 20 in the embodiment shown in FIGS. 4-7, any other suitable means of attachment may be used in accordance with the present invention.

FIG. 8 illustrates the rear of a bit puller plate 40 in accordance with another embodiment of the present invention. The embodiment shown in FIG. 8 is similar to the previous embodiments, except a generally rectangular striking pad 42 is used instead of a circular striking pad. The rectangular striking pad 42 may be attached to the back end 26 of the bit puller plate 40 by any suitable means such as adhesives, press fittings, mechanical fasteners, welding and the like. The rectangular striking pad 42 may include an extended portion (not shown) which is received in a corresponding recess (not shown) in the back end 26 of the bit puller plate 40. For example, the rectangular striking pad 42 may have a rectangular extension or, alternatively, a circular extension similar to the circular extension 32 shown in FIGS. 4, 5 and 7. In addition to rectangular and circular cross sections, any other suitable shape of striking pad may be used in accordance with the present invention.

Although the pullers shown in the figures have generally wedge shaped forks 24a and 24b, other fork shapes may be used in accordance with the present invention. For example, the forks may be substantially flat instead of wedge shaped. Furthermore, although the pullers illustrated in the figures include a handle 28 extending at an angle from the top of the bit puller plate 20, other handle arrangements may be used in accordance with the present invention. For example, a handle may extend from the back end of the bit puller plate. In this case, the striking pad may be mounted at the end of the handle at the back end of the bit puller plate.

Whereas particular embodiments of this invention have been described above for purposes of illustration, it will be evident to those skilled in the art that numerous variations of the details of the present invention may be made without departing from the invention as defined in the appended claims.

1. A mining bit puller for extracting mining tool bits, the puller comprising a bit puller plate including two forks at a front end of the plate and a striking pad at a back end of the plate.

2. The mining bit puller of claim 1, wherein the striking pad comprises a resilient material.

3. The mining bit puller of claim 1, wherein the striking pad comprises a polymer material.

4. The mining bit puller of claim 1, wherein the striking pad is mechanically fastened to the bit puller plate.

5. The mining bit puller of claim 4, wherein the striking pad comprises a threaded bolt extending into a threaded hole in the bit puller plate.

6. The mining bit puller of claim 1, wherein the striking pad is fastened to the bit puller plate by an adhesive.

7. The mining bit puller of claim 1, wherein the striking pad is fastened to the bit puller plate by a press fitting.

8. The mining bit puller of claim 1, wherein at least a portion of the striking pad is inserted into a recess in the bit puller plate.

9. The mining bit puller of claim 1, wherein the striking pad comprises an extended portion received with a recess in the bit puller plate.

10. The mining bit puller of claim 9, wherein the extended portion of the striking pad has a circular cross section.

11. The mining bit puller of claim 9, wherein the extended portion of the striking pad has an axial length smaller than an axial length of the remainder of the striking pad.

12. The mining bit puller of claim 1, wherein the striking pad has a circular cross section.

13. The mining bit puller of claim 1, wherein the striking pad has a rectangular cross section.

14. The mining bit puller of claim 1, wherein the striking pad comprises a metal plate and a resilient material attached to the metal plate.

15. The mining bit puller of claim 14, wherein the resilient material at least partially surrounds the metal plate.

16. The mining bit puller of claim 14, wherein the metal plate of the striking pad is mechanically fastened to the bit puller plate.

17. The mining bit puller of claim 16, further comprising a threaded bolt attached to the metal plate of the striking pad and received in a threaded hole in the bit puller plate.

18. The mining bit puller of claim 14, wherein the metal plate of the striking pad is welded to the bit puller plate.

19. The mining bit puller of claim 1, wherein the forks are generally wedge shaped.

20. The mining bit puller of claim 1, further comprising a handle extending from the bit puller plate.

21. The mining bit puller of claim 20, wherein the handle extends from a top surface of the bit puller plate at an angle of less than 90 degrees with respect to a plane defined by the bit puller plate.

22. The mining bit puller of claim 21, wherein the handle comprises a hand grip at an end thereof.

23. A mining bit puller for extracting mining tool bits, the puller comprising a bit puller plate including two forks at a front end of the plate and a back end of the plate structured and arranged to receive a striking pad.

24. The mining bit puller of claim 23, wherein the back end of the bit puller plate comprises a threaded hole for receiving a threaded bolt of the striking pad.

25. The mining bit puller of claim 23, wherein the back end of the bit puller plate comprises a recess for receiving at least a portion of the striking pad.

26. The mining bit puller of claim 25, wherein the recess is circular.

27. A striking pad for a mining bit puller, the striking pad comprising:
a striking surface; and
means for connecting the striking pad to the mining bit puller.

28. The striking pad of claim 27, wherein the connecting means comprises a mechanical fastener.

29. The striking pad of claim 27, wherein the connecting means comprises a threaded bolt extending from an opposite side of the striking pad from the striking surface.

30. The striking pad of claim 27, wherein the striking pad comprises an extended portion structured and arranged to be received in a recess of the mining bit puller.

31. The striking pad of claim 30, wherein the extended portion has a circular cross section.

32. The striking pad of claim 30, wherein the extended portion has an axial length smaller than an axial length of the remainder of the striking pad.

33. The striking pad of claim 27, wherein the striking pad comprises a metal plate and a resilient material, and the resilient material at least partially surrounds the metal plate and covers the striking surface.
